(19) United States
(12) Patent Application Publication
(10) Pub. No.: US 2024/0428560 A1
(43) Pub. Date: Dec. 26, 2024

(54) SENSOR-SUPPORTED OBJECT CHARACTERIZATION AS STATIC OR DYNAMIC

(71) Applicant: Intel Corporation, Santa Clara, CA (US)

(72) Inventors: Cornelius BUERKLE, Karlsruhe (DE); Fabian OBORIL, Karlsruhe (DE); Leon JUNGEMEYER, Markdorf (DE)

(21) Appl. No.: 18/525,880

(22) Filed: Dec. 1, 2023

(30) Foreign Application Priority Data
Jun. 22, 2023 (DE) 10 2023 116 500.3

(51) Int. Cl. G06V 10/764; B25J 9/16; G06T 7/50; G06T 15/00; G06V 20/70

(52) U.S. Cl. CPC G06V 10/764; B25J 9/1664; G06T 7/50; G06T 15/00; G06V 20/70

(57) ABSTRACT

A device for detecting a dynamic object, comprising a processor configured to determine a first point density of a first volume around a first point in a first image, the first image being an image of an environment of a robot, the image including image 3D data; determine one or more second point densities, wherein each second point density is a point density of a second volume about a second point, wherein the second point corresponds to the first point in each of one or more second images, the one or more second images of the environment being one or more images taken prior to the first image and including image data corresponding to the three dimensions; and classify the first point as dynamic or static based on a comparison of the first point density and the one or more second point densities.

### CROSS-REFERENCE TO RELATED APPLICATIONS

This application claims priority to German Patent Application 10 2023 116 500.3, filed on Jun. 22, 2023, the entire contents of which are incorporated herein by reference.

### TECHNICAL FIELD

Various aspects of this description relate generally to the use of image data comprising depth information (e.g. a depth image, Light Detection and Ranging (LiDAR) data, etc.) to characterize an object as a static or dynamic object.

### BACKGROUND

Autonomous mobile robots or stationary robots with autonomously movable limbs (mobile robots for short in the following) are subject to strict safety requirements, for example if they are used in the vicinity of humans, work directly with humans or may cause damage to infrastructure. Current efforts to protect humans working directly or in close proximity to robots often rely on Light Detection and Ranging (LiDAR) sensors that are either attached to or in the vicinity of a mobile robot. As soon as these sensors detect an object in the safety-relevant vicinity of the robot, the robot is instructed to check safety-relevant or hazardous aspects and, if necessary, to take appropriate action, e.g. to reduce its speed or even stop completely.

One challenge with such solutions is that it is difficult for them to distinguish between a moving object (e.g. a person) in the immediate vicinity of the mobile robot and a stationary object (e.g. a wall, table, etc.). In view of this deficit, existing safety solutions assume a worst-case scenario for each detected object in order to ensure comprehensive protection of the human or the infrastructure. Specifically, the robots assume that the object is moving towards the robot at a defined speed. This defined speed may be based, for example, on the American National Institute of Standards (ANSI) safety standard RIA 15.06, which may be too conservative and therefore relatively impractical for environments that are mainly static (e.g. environments with few dynamic objects). In particular, current practices and/or standards may unduly restrict, e.g. slow down, the approach of mobile robots to static objects.

### BRIEF DESCRIPTION OF THE DRAWINGS

In the drawings, the same reference signs in the different views generally refer to the same parts. The drawings are not necessarily to scale; emphasis is rather generally placed on illustrating the exemplary principles of the disclosure. In the following description, various exemplary embodiments of the disclosure are described with reference to the following drawings, in which:

FIGS. 1 and 2 show considerations for movement in the vicinity of dynamic objects compared to static objects;

FIG. 3 shows a safety system that recognizes whether an object is static or dynamic;

FIG. 4 shows the occlusion of a point or a group of points by a moving object;

FIGS. 5A and 5B show a first object that obscures the view of a second object;

FIGS. 6A, 6B and 6C show the change in a volume due to the movement of a device;

FIGS. 7A, 7B and 7C show the change in a volume due to the movement of an object;

FIGS. 8A and 8B show an image of an object in three-dimensional space that is converted into an image of an object in two-dimensional space;

FIG. 9 shows an occupancy grid with four states;

FIG. 10 shows another occupancy grid with fewer states; and

FIG. 11 shows a device for detecting a dynamic object.

### DESCRIPTION

The following detailed description refers to the accompanying drawings, which illustratively show exemplary details and embodiments in which aspects of the present disclosure may be implemented.

The word “exemplary” is used herein with the meaning “serving as an example, case or illustration”. Any embodiment described herein as “exemplary” is not necessarily to be construed as preferred or advantageous over other embodiments or designs.

It should be noted in the drawings that identical reference signs are used to represent the same or similar elements, features and structures, unless indicated otherwise.

The wording “at least one” and “one or more” may be understood to include a numerical quantity greater than or equal to one (e.g., one, two, three, four, [ . . . ], etc.). The wording “at least one of” with respect to a group of elements may be used herein to mean at least one element of the group consisting of the elements. For example, the wording “at least one of” with respect to a group of elements may be used herein to mean a selection of the following: one of the listed elements, a plurality of one of the listed elements, a plurality of individual listed elements, or a plurality of several individual listed elements.

The words “plurality” and “several” in the description and in the claims explicitly refer to a set of more than one. Accordingly, any formulations explicitly reciting the above-mentioned words (e.g., “plurality of [elements]”, “several [elements]”) that refer to a set of elements explicitly refer to more than one of the elements. For example, the wording “a plurality” may be understood to include a numerical quantity greater than or equal to two (e.g., two, three, four, five, [ . . . ], etc.).

The phrases “group (of)”, “set (of)”, “collection (of)”, “series (of)”, “sequence (of)”, “grouping (of)”, etc., refer in the description and in the claims, if any, to a set equal to or greater than one, i.e., one or more. The expressions “true subset”, “reduced subset” and “smaller subset” refer to a subset of a set that is not equal to the set, illustratively referring to a subset of a set that contains fewer elements than the set.

The term “data” as used herein may be understood to include information in any suitable analog or digital form provided, for example, as a file, a part of a file, a set of files, a signal or a stream, a part of a signal or stream, a set of signals or streams, and the like. Further, the term “data” may also be used to mean a reference to information, for example in the form of a pointer. However, the term “data” is not limited to the foregoing examples and may take various forms and represent any information as understood in the art.

The terms “processor” or “controller” as used herein, for example, may be understood as any type of technological entity that allows the handling of data. The data may be handled according to one or more specific functions performed by the processor or controller. Further, as used herein, a processor or controller may be understood as any type of circuit, such as any type of analog or digital circuit. Thus, a processor or controller may be or include an analog circuit, a digital circuit, a mixed-signal circuit, a logic circuit, a processor, a microprocessor, a central processing unit (CPU), a graphics processing unit (GPU), a digital signal processor (DSP), a field programmable gate array (FPGA), an integrated circuit, an application specific integrated circuit (ASIC), etc., or any combination thereof. Any other type of implementation of the respective functions described in more detail below may also be understood to be a processor, controller or logic circuit. It will be understood that any two (or more) of the processors, controllers, or logic circuits described in detail herein may be realized as a single entity having equivalent functionality or the like, and conversely, that any single processor, controller, or logic circuit implemented herein may be realized as two (or more) separate entities having equivalent functionality or the like.

As used herein, “memory” is understood to mean a storage element or computer-readable medium (e.g., a non-volatile computer-readable medium) in which data or information can be stored for retrieval. References included herein to “memory” may thus be construed to refer to volatile or non-volatile memory, including but not limited to random access memory (RAM), read-only memory (ROM), flash memory, semiconductor memory, magnetic tape, a hard disk, an optical drive, 3D XPoint™, or any combination thereof. Also included in the term memory herein are, amongst others, registers, shift registers, processor registers, data buffers, etc. Memory may be local memory, wherein the memory is electrically conductively connected to a processor that reads data from and/or stores data in the memory. Alternatively or additionally, memory may be remote memory, such as memory accessed by a processor via a communication protocol (e.g., via an Internet protocol, a wireless communication protocol, etc.). Remote storage may include cloud storage. The term “software” refers to any type of executable instruction, including firmware.

Unless expressly stated, the term “transmit” includes both direct transmission (point-to-point) and indirect transmission (via one or more intermediate points). Similarly, the term “receive” includes both direct and indirect reception. Further, the terms “transmit”, “receive”, “communicate” and other similar terms include both physical transmission (e.g., the transmission of radio signals) and logical transmission (e.g., the transmission of digital data over a logical connection at the software level). For example, a processor or controller may transmit or receive data with another processor or another controller in the form of radio signals over a software-level link, where the physical transmission and the physical reception are handled by radio layer components, such as RF transceivers and antennas, and the logical transmission and the logical reception are handled by the processors or controllers over the software-level link. The term “communicate” includes transmitting and/or receiving, i.e. unidirectional or bidirectional communication in one or both of the incoming and outgoing directions. The term “calculate” includes both “direct” calculations via a mathematical expression/mathematical formula/relationship and “indirect” calculations via lookup or hash tables and other array indexing or searching operations.

Unless explicitly stated, the term “image” includes image data containing both 2D and 3D information. Such “images” according to this definition may be, amongst others, depth information images (e.g. distance information images) or point clouds (e.g. 3D point clouds). This applies in particular to images that contain image data corresponding to three or four (3D plus time) dimensions.

Mobile robots generally have difficulty distinguishing between dynamic and stationary objects. This applies both to LiDAR-based robots (which are unable to distinguish between static and dynamic objects when evaluating a single scan) and to robots that rely on certain advanced safety systems (where such a distinction between static and dynamic objects is not part of the safety concept/algorithms). Since mobile robots do not determine whether the detected objects are dynamic or static objects, and in order to ensure safe operation under all conditions, current safety systems for mobile robots assume that all objects are potentially dynamic and can therefore potentially move towards the robot at a certain speed (worst case).

ANSI/RIA 15.06 states, for example, that it should be assumed that a human can move 1.5 meters/second towards a mobile device. Assuming a hypothetical stopping time of the robot of τ=0.5 seconds and a stopping distance of d_robot=1 meter, the required safety distance is 1.75 meters (stopping distance of the robot+distance covered by the human during the stopping time). Therefore, the robot must maintain an additional (unnecessary) safety distance of 0.75 meters for each stationary object (e.g. a wall). Depending on the robot's environment, this can significantly affect the robot's usability or efficiency or require additional, expensive countermeasures, e.g. restricting human access to certain areas.

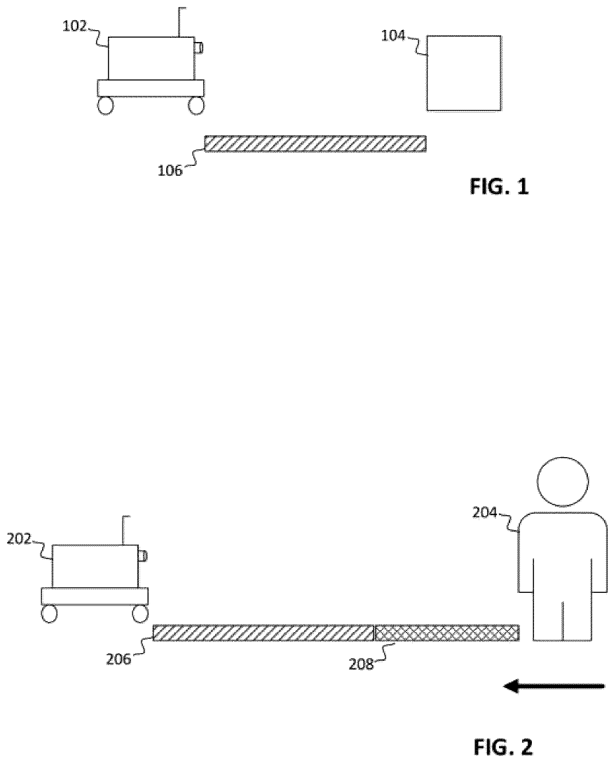

FIG. 1 and FIG. 2 illustrate the above considerations regarding dynamic and static objects. In FIG. 1, a robot 102 is approaching a static obstacle 104. The distance between the robot 102 and the static obstacle 104 is represented by 106. Assuming the values described in the previous section, the robot 102 has a braking distance of 1 meter and can therefore approach any static object to within 1 meter while still maintaining an appropriate safety distance to avoid collisions. In FIG. 2, however, the robot 202 is approaching a human 204, and since the human 204 is a dynamic object or is assumed to be a dynamic object, an additional safety distance is required. This means that the stopping distance of 1 meter shown as 106 in FIG. 1 is shown here as 206. In addition, the distance covered by the human 204 during the stopping time of the robot 202 is shown as 208. As can be seen from this figure, the safety distance of the robot from a dynamic object is greater than the safety distance of the robot from a static object.

Many approaches that could address the problem of static/dynamic object segmentation ignore the safety requirements or do not adequately address the safety requirements. Such approaches may include learning-based solutions such as object detectors (e.g. Yolo, PointPillars, etc.), which are not approved by safety certification bodies. Object trackers based on Kalman filters are also not applicable as these require, for example, tracking 3D bounding boxes, which may not be available within the security path (such 3D bounding boxes are more likely to detect if something is too close than how the object is shaped), or provide an estimate of object positions and orientation. 3D bounding boxes typically reduce efficiency because the actual distance to actual objects can be greater than to the bounding box. Finally, there are dynamic occupancy grid approaches that use, for example, particle filters to identify moving scene elements; however, these are extremely computationally intensive and therefore may be difficult to implement for performing high-frequency safety tasks in mobile robots.

In order to reduce the above-mentioned shortcomings of modern safety systems for mobile robots, a solution or system is described that can distinguish between dynamic and static environmental elements. For this purpose, the system may use a high-resolution 3D depth sensor (a depth camera or a modern LiDAR sensor) as an input source. Alternative input devices may be conventional image sensors (e.g. cameras arranged at a distance from one another) for which one or more photogrammetry techniques can be implemented to obtain 3D data from the multiple images. The system can then convert the data (if required, as with the depth sensor data) into a 3D point cloud. The system can then compare the density of this cloud for any region with the regional density of point clouds from previous images. Any significant increase/decrease in density can be taken as an indication that something has moved in the scene. In a subsequent analysis, the dynamic elements can be identified and separated from the static elements (which can be done on a 2D or 3D occupancy grid). Finally, the system can adjust the required safety distances so that the robot can move closer to static scene elements (e.g. walls) while maintaining larger safety distances to dynamic elements. The required safety distance can also be obtained from characteristics or properties of the objects, e.g. a maximum acceleration or maximum speed of a mobile robot.

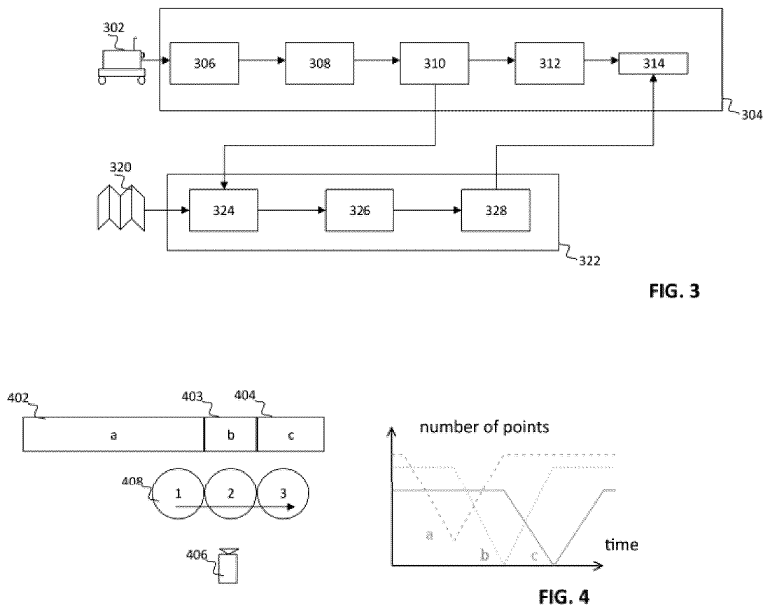

FIG. 3 shows a safety system that recognizes whether an object is static or dynamic. In this system, the robot 302 is equipped with one or more sensors to obtain information about the robot's environment. As described above, these sensors may be a LiDAR device, a depth camera, or depth information obtained from 2D images using one or more photogrammetry techniques. The acquisition or generation of depth information is shown as 306. In 308, the system converts the depth information into a 3D point cloud. In 310, the 3D point cloud is further processed to remove traversable surfaces from the 3D point cloud (e.g., surfaces that are or will be traversed by the robot). In 312, the resulting point cloud, from which the traversable surfaces have been removed, is projected onto a grid. In the next line, using localization information 320 (GPS information, triangulation information or other information for localizing the robot 302), multiple point clouds from 310 are matched to each other. That is, a current point cloud of 310 is aligned with one or more previous point clouds of 310 using the localization information 320. For a given point on the current 3D point cloud, the system compares the point density in a volume (e.g., a three-dimensional space) around the given point to a point density of the volume around a corresponding point on the one or more previous 3D point clouds. If the point density changes in the current volume and in the previous volume, this indicates a movement within this volume, or otherwise that the volume corresponds to a dynamic object. Using this technique, at step 326, the system may label one or more points of the current 3D point cloud as dynamic or static. The system may then convert the labeled 3D point cloud into a grid in which regions of the grid are labeled as corresponding to a static or dynamic object. This grid may then be received by the safety controller 314. This grid from step 328 largely corresponds to the grid from step 312, with the exception that the grid from step 328 includes a labeling as static or dynamic, whereas this would not be possible in the grid from step 312. Based on the labeled grid, the safety controller 314 determines a safe behavior (e.g., a safe stopping path, a stopping routine, etc.) depending on whether the respective object in the vicinity of the robot is detected as dynamic or static.

The conversion of 3D image data into a 3D point cloud is well known and can be achieved using a multitude of methods. Those skilled in the art will understand that various methods or this type are available, and that any such method may be used to convert 3D information into a point cloud without limitation.

While filtering the 3D point cloud to remove traversable regions, as shown in step 310, is not essential to the methods disclosed herein, it can simplify the categorization of objects as dynamic or static since the resulting image will only include points that relate to obstacles and not to paths along which the robot can move. Various methods for removing motion paths from the 3D point cloud are known, and those skilled in the art will understand that any of these methods can be used for the purposes of the present disclosure.

Projecting the image onto a grid (also known as grid extraction), as shown in step 312 and step 328, can optionally be accomplished by ignoring the Z-value of each point within the 3D point cloud. This ignoring of the Z-value results in a two-dimensional image, which can greatly simplify subsequent processing of the image data.

In the procedures described here, it may be necessary for the system to determine whether a cell (e.g. a cell of the grid during or after grid extraction) is occupied or unoccupied. A cell in the grid can be defined as occupied if a number of projected points per cell is outside a range. Similarly, the cell in the grid can be defined as unoccupied if the number of projected points per cell is within the range. Alternatively, this can be done with a threshold value so that the cell is defined as occupied if the number of points within the cell exceeds the threshold value and the cell is defined as unoccupied if the number of points within the cell is below the threshold value.

If the occupied cell is within the robot's specified safety zone, the robot must slow down or stop. However, the safety zone itself depends on whether the cell is defined for a dynamic or a static object.

Regarding the alignment of the point clouds in step 324, it may be necessary to analyze the environment by means of successive images (e.g., sometimes several successive images) to identify an object as dynamic or static. For such an analysis, all point clouds must be located in the same coordinate system with the same reference point. This may be, for example, a global coordinate system (e.g. a target coordinate system) that is similar to a map frame, such as is used in a SLAM (Simultaneous Localization and Mapping) approach for localization. This can be implemented using the robot's position sensor, for example. A position corresponding to the robot's position sensor is recorded for each point in time that corresponds to a specific point cloud. The point clouds are then resolved relative to each other.

It should be noted that both the global coordinate system and the position of the robot (e.g. via the localization sensor) can be used in this method. The global coordinate system is static and therefore does not change depending on the movement of the robot. In order to align the images (e.g. the point clouds) relative to the global coordinate system, it may be necessary to determine the position of the robot relative to the global coordinate system at each point in time corresponding to a 3D point cloud. Thus, if a predetermined global coordinate system exists, the position of the robot can be determined based on a localization sensor relative to the predetermined global coordinate system, and this relationship can be used to align the 3D point clouds.

In some configurations, the robot may be configured with multiple image sensors, such as multiple LiDAR devices or even multiple depth cameras or multiple image sensors from which depth information is obtained by one or more photogrammetry techniques. In such configurations, the system can fuse the different resulting point clouds as described above, but in such a way that for each time step exactly one uniform (and filtered) point cloud is generated for the given global coordinate system.

In step 326, the system classifies points (e.g., all points, some points, or less than all points) within a given point cloud as either static or dynamic. It is assumed that regions in a three-dimensional space where measurements are made that cannot be explained by previously obtained point clouds represent either newly identified areas or dynamic objects.

For this analysis, the system can limit its examination to the points (e.g. all points, some points or at least less than all points) of a specific point cloud. For example, the point cloud may be the point cloud of 310/324, where the traversable areas have been omitted. The analysis may be performed point by point for a particular point p of the current point cloud P₀, i.e., for a particular point p, a radius in three-dimensional space (e.g., a volume) around the point p in the current point cloud and in one or more previous point clouds is evaluated. For example, if F is the set of sensor data or point clouds, then a simple definition of the state s of p is given by:

$$s ( p ) = \{ \begin{matrix}static , & if \frac{1}{\vert F \vert} {\sum }_{f ∈ F} \vert {r}_{f} ( p ) - {r}_{0} ( p ) \vert < δ \\ & otherwise dynamic\end{matrix} \qquad ( 1 )$$

That is, if the average of the differences between the number p of points within a volume surrounding a reference point on one or more previous point clouds r_{f}(p) and the number of points within a volume surrounding a corresponding reference point on a current point cloud rₒ(p) is less than a predetermined threshold δ, then the point in the current point cloud is said to be static, otherwise the point in the current point cloud is said to be dynamic.

Otherwise, a point is considered to be part of a static object, i.e. if the density around the point between the current point cloud and one or more newer point clouds does not change, or at least does not change significantly. However, if the density around the point changes significantly between the current point cloud and one or more newer point clouds, the point is said to be dynamic.

Unfortunately, this approach can have certain undesirable weaknesses in practice. For example, a moving robot may recognize objects as larger or smaller depending on how close it is to the object, which may need to be compensated for. In addition, a particular object may be temporarily obscured by one or more other objects and/or suddenly reappear in the robot's line of sight as soon as the obscuring object is no longer in the way. Without further ado, this can erroneously lead to a static object being temporarily marked as dynamic. These potential deficiencies are addressed below with one or more optional procedures or functions to remedy these deficiencies.

In a first optional configuration, the system can take into account the point visibility of a moving robot. This means that a certain point (e.g. a point on a wall) may be visible in one image but obscured in another image due to the movement of the robot (or a corresponding object). In such a case, equation (1) would indicate a dynamic object, as the point density for a volume around a certain point would change between a current image and a previous image. However, this could be wrong, since a point on a wall, for example, can always remain static even if the moving robot detects a change in the point density around the point on the wall (e.g. due to an object temporarily occluding the point on the wall). To solve this problem, the visibility of the point should be taken into account.

A particular point may be invisible to the robot either because it is outside the field of view of the sensor (e.g. image sensor, LiDAR, etc.) or because it is obscured by a closer object. To determine whether either case applies, the system can project the point cloud P₀ for each sensor position within F onto the sensor frame (e.g. a two-dimensional image plane). An underlying assumption is that a point that was outside the sensor frame for a particular image was not visible to the robot in this image. However, if a point is in the sensor frame, e.g. on the pixel (i,j), the processor can compare an estimated distance with the distance measured on the pixel for this image. If the estimated distance is greater than the measured distance, the object in this particular image has been obscured by another object. This results in a visibility function that can be described as follows:

$$v ( p , f ) = \{ \begin{matrix}invisible , p ∉ image plane for image planes f \\ invisible , measured distance < estimated distance \\ otherwise visible\end{matrix} \qquad ( 2 )$$

Otherwise, a particular point p is invisible to the robot if it is not represented in this sensor frame (if it is located outside the sensor frame) or if the measured distance to point p is less than an estimated distance to point P (which means, for example, that there is another object between the robot and the expected object at point p).

FIG. 4 shows the occlusion of a point or a group of points by a moving object. In this figure, a surface is divided into three sections, section a 402, section b 403 and section c 404. The image sensors 406 of the robot are aligned with the surface with sections a, b and c. An object 408 moves from left to right between the surface and the image sensors 406. On the right-hand side, a diagram shows the number of points of sections a, b and c that are visible to the robot. Initially, all points of section a 402, section b 403 and section c 404 are visible to the image sensors 406. As the object 408 moves from left to right, the object begins to obscure the view of the image sensor 406 of section a 402, reducing the number of points visible to the image sensor. Gradually, the moving object 408 obscures less of section a 402 and begins to obscure section b 403. In this case, the number of points visible for section a increases, while the number of points visible for section b decreases. Gradually, the moving object 408 obscures less of section b 403 and more of section c 404. Accordingly, the number of visible points for section b increases and the number of visible points for section c decreases.

To correct this phenomenon, the state function can be updated so that the amount of sensor data F to be analyzed is replaced by F′, wherein:

$${F}^{′} = \{ f \vert f ∈ F \qquad ( 3 )$$

$$and$$

$$v ( p , f ) == visible \}$$

As this function can lead to an empty set, a point may only be classified as static if |F′|>m, where m is a user-defined threshold value. In other words:

$$( 4 )$$

$$s ( p ) = \{ \begin{matrix}static , if \vert {F}^{′} \vert > m ∧ \\ \frac{1}{\vert {F}^{′} \vert} {\sum }_{f ∈ {F}^{′}} \vert {r}_{f} ( p ) - {r}_{0} ( p ) \vert < δ for {F}^{′} = \{ f \vert f ∈ F ∧ v ( p , f ) == visible \} \\ otherwise dynamic\end{matrix}$$

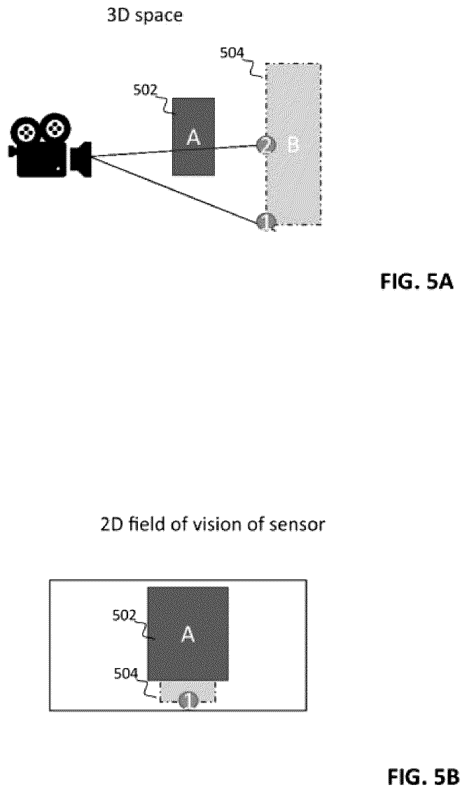

FIG. 5A shows a first object 502 occluding the view of a second object 504. Due to the arrangement of the first object 502 with respect to the image sensor and the second object 504, the first object 502 and the second object 504 appear to the image sensor as shown in FIG. 5B, with only a portion of the second object 504 being visible as most of the second object 504 is occluded by the first object 502. Since the images captured by the corresponding image sensors, depth cameras, LiDAR, etc. include depth information, the system can determine the depth information of each visible portion of the second object 504. In this way, the system can determine a relative distance between the image sensors (depth cameras, LiDAR, etc.) and the second object 504. Using simple geometric principles, the robot can also estimate the distance between itself and any occluded portion of the second object 504. Since the first object 502 occludes a major part of the surface of the second object 504, a major part of the depth information associated with the direction of the second object 504 corresponds to the distance between the image sensors and the first object 502. Since the first object 502 is located closer to the image sensors than the second object 504, the robot can determine whether the depth information associated with a particular point is less than the estimated distance between the robot (e.g., the image sensors) and the second device 504 (this estimated distance may also be referred to as the projected distance). If the distance associated with the depth information is less than the estimated distance/projected distance, it may be assumed that the particular point (the particular portion of the view of the second object 504) is obscured by the first object 502.

In an optional second configuration, the data to be analyzed can be changed based on changes in the distance between the robot and the corresponding object. As the robot approaches or moves away from a particular (stationary) object, the number of corresponding detection points changes (e.g. increases or decreases) as the object appears larger or smaller in the robot's sensor image. Under certain circumstances, this can lead to a stationary object being incorrectly recognized as dynamic, as the change in the apparent size of the object can lead to a change in the corresponding point density.

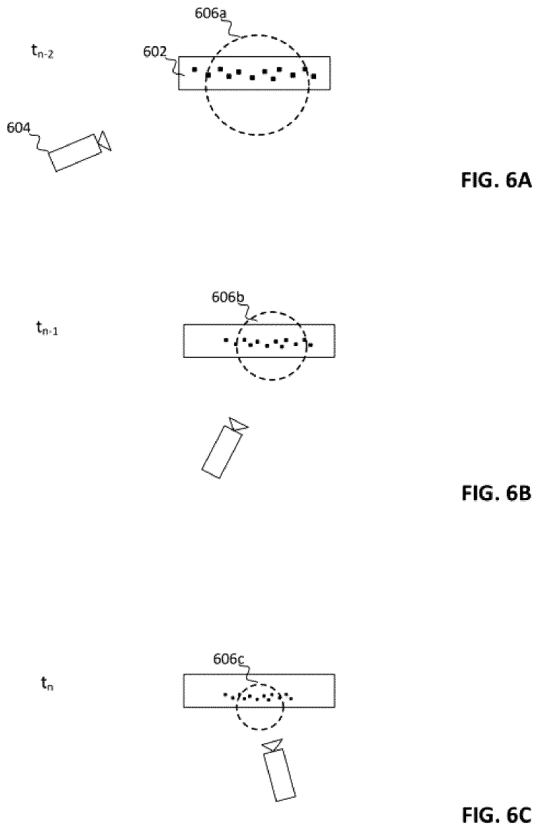

FIGS. 6A, 6B and 6C illustrate changes in the point volume according to this optional aspect of the description. In FIG. 6A, an object 602 is viewed by one or more image sensors of the robot 604, and a volume corresponding to 606a (a two-dimensional region is shown, but a three-dimensional volume is intended) is evaluated according to the methods described herein. As the robot moves (in this case, toward the object 602), changes can be made, as illustrated in FIG. 6B and FIG. 6C. In FIG. 6B, the robot further evaluates a volume corresponding to a part of the surface 602. In this case, it can be seen that the distance between the robot and the surface 602 is smaller in FIG. 6B than in FIG. 6A. Since the robot is now closer to the surface 602, the surface appears larger in the robot's sensor field. To compensate for this, the volume 606b to be examined is reduced. The result is that the same number (or a comparable number) of points are present in 606b as in 606a, since 606b is larger in the image section of the robot. Similarly, in FIG. 6C, the robot has moved even closer to the object 602 so that the volume 606c to be examined is even smaller, so that the same number of points are present in each of 606a, 606b and 606c, taking into account the relative change in size of each of 606a, 606b and 606c from the perspective of the robot. In this way, the object is classified as static despite the movement of the robot (and therefore despite the volume otherwise appearing to be ever larger).

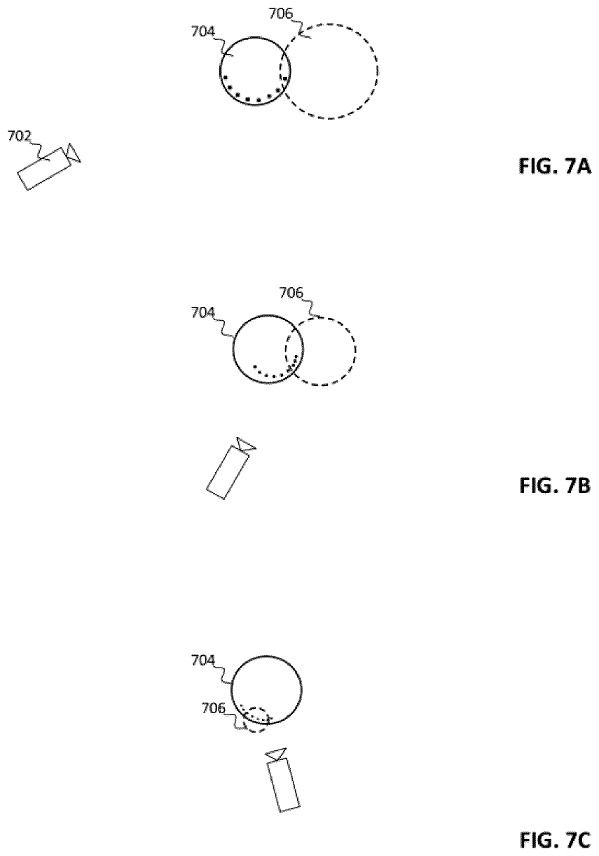

FIGS. 7A, 7B and 7C illustrate this process for a dynamic object. In FIG. 7A, the image sensors of the robot 702 capture an image of an object 704, wherein the image is processed according to the steps described herein and a corresponding volume 706 is analyzed for point density. In FIG. 7A, the volume 706 only slightly overlaps the object 704, so that only a few points correspond to the object 704. In FIG. 7B, both the robot and the object 704 have moved, and as the robot has moved closer to the object 704, the size of the volume 706 has decreased to compensate for the otherwise larger appearing object). The change in the size of the volume compensates for the movement (the change in position) of the robot relative to its previous position in FIG. 7A. However, since the object 704 is dynamic and also moves closer to the robot, a larger number of points corresponding to the object 704 are detected in the volume 706. To further illustrate this process, FIG. 7C shows that the robot moves even closer to the object 704, and that this decreased distance between the robot and the object 704 results from both the movement of the robot and the movement of the object 704. The size of the volume 706 is further reduced due to the movements of the robot. However, due to the movements of the object, the number of points detected within the volume 706 is larger than in FIG. 7B. In this way, the object 704 is classified as dynamic.

In other words, as the robot approaches or moves away from a particular (stationary) object, the number of detected points within the volume will naturally increase (or decrease) as the object appears larger (or smaller) in the sensor image. This must be taken into account, as a static object could otherwise be classified as dynamic simply because it appears larger (e.g. because it leads to a higher point density). Therefore, the system can rely on the projection of the sensor field, where the search radius rs (which corresponds to a size of the volume, a radius of the volume) for the frame (time step) f is defined as follows:

$${r}_{f} ( p ) = {d}_{f} ( p ) \times R$$

In this formula, R can be a fixed (user-defined or predefined) search radius in points (e.g. on the sensor frame), and d (p) can be the distance of point p from the sensor plane. Consequently, the search radius can be larger for more distant points and smaller for closer points. This can be seen in FIGS. 7A, 7B and 7C, which show that closer objects use a smaller effective search radius in three dimensions, while more distant objects use a larger radius.

Although the skilled person knows that this can be implemented in various ways, one possible method for implementing this procedure is shown in the following pseudo code:

Data: A scan Sₜ, point cloud Pₜ ∈ Sₜ in world coordinates with initial labels

p_{L} = undefined for each p ∈ pₜ, a history H = [Sₜ₋ₙ [symbol] Sₜ₋₁] of previous scans

Result: Point cloud Pₜ with labels p_{L} ∈ {dynamic, static, unknown}
foreach point p ∈ Pₜ do

| \| | neighbors ← 0; | |
|---|---|---|
| \| | t_{visible} ← 0; | |
| \| | foreach scan Sₜ ∈ H do | |
| \| | \| | if visible(p, Sₜ) then |
| \| | \| | \| t_{visible} ← t_{visible} + 1; |
| \| | \| | \| rₚ ← distance(p [symbol] Sₜ [symbol] robot_location) * PIXEL_RADIUS; |
| \| | \| | \| neighbors ← neighbors + radius_search (Sₜ [symbol] point_cloud,p,rₚ); |
| \| | \| | end |
| \| | end | |
| \| | if t_{visible} < MIN_OBSERVATIONS then | |
| \| | \| | p_{L} ← unknown ; |
| \| | \| | continue; |
| \| | end | |
| \| | neighbors_avg ← neighbors/t_{visible}; | |
| \| | rₚ ← distance(p, Sₜ.robot_location) * PIXEL_RADIUS; | |
| \| | neighbors_current ← radius_search(Sₜ [symbol] point_cloud, p, rₚ); | |
| \| | if neighbors_avg / neighbors_current < DENSITY_THRESHOLD then | |
| \| | \| | p_{L} ← dynamic; |
| \| | else | |
| \| | \| | p_{L} ← static; |

| | |
|---|---|
| \| | end |

end [symbol]
indicates data missing or illegible when filed

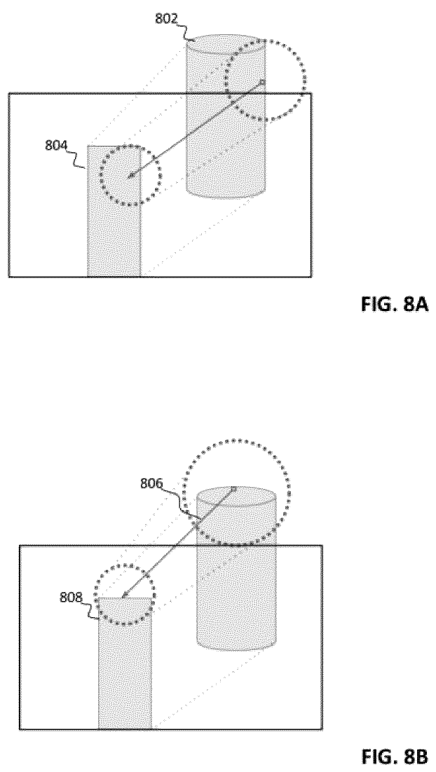

According to a third optional implementation, the process of detecting motion within an object to classify the object as dynamic or static can be simplified by performing a neighborhood search in a two-dimensional space. A radius search (a search within a volume) within a three-dimensional point cloud is computationally intensive. The associated computational cost can be understood as O(n²) where n is the number of points. To reduce this complexity, it may be desirable to perform the neighborhood search in two-dimensional image space, since every neighbor in 3 dimensions is also a neighbor in 2 dimensions. This is shown at least in FIGS. 8A and 8B.

In FIG. 8A, a representation of an object in three-dimensional space 802 is converted into a representation of an object in two-dimensional space 804, e.g. by ignoring the Z access information within the point cloud. A neighborhood search, as indicated by the dashed circle, produces comparable results in a two-dimensional environment. In other words, instead of searching a three-dimensional volume, only a two-dimensional area is searched to determine the point density. The two-dimensional area search is less computationally intensive than the three-dimensional volume search. Similarly, FIG. 8B shows how a three-dimensional image 806 is converted to a two-dimensional image 808 and the neighborhood search of the three-dimensional volume (shown by the dashed circle on the right-hand side) is performed as a two-dimensional area (shown by the dashed circle on the left-hand side).

In a fourth optional implementation, the system can be configured to use an unknown state. So far, only two states have been used in this description: static or dynamic. However, to enable a more meaningful and safer state transition, a third state (e.g. an unknown state) can be introduced. In this way, a newly discovered point (or a region or a grouping of points) can be labeled as unknown (e.g., it is known whether the object is dynamic or static) until enough measurements are available to reliably classify the point as static or dynamic. This enables a faster transition (e.g. after a few images) from an unknown state to a static or dynamic state without having to enable a similarly fast transition between dynamic and static states. In this context, it is noted that fast transitions between dynamic and static states may generally be undesirable, as such rapid transitions may result in a human worker who stops for a short time being classified as static, whereas a longer classification as dynamic may be considered safer and/or may be necessary to comply with certain safety regulations. Furthermore, without the unknown state, all newly detected points would have to be classified as dynamic, which would lead to the problem that a long transition from dynamic to static would eventually result in an environment where everything is labeled as dynamic.

This configuration could be solved as follows:

$$s ( p ) = \{ \begin{matrix}\begin{matrix}static , if \vert {F}^{′} \vert > m ∧ \frac{1}{\vert {F}^{′} \vert} {\sum }_{f ∈ {F}^{′}} \vert {r}_{f} ( p ) - {r}_{0} ( p ) \vert < δ for {F}^{′} = \\ \{ f \vert f ∈ F ∧ v ( p , f ) == visible \}\end{matrix} \\ unknown , if \vert {F}^{′} \vert \leq m \\ otherwise dynamic\end{matrix} \qquad ( 5 )$$

After creating the labeled point cloud, the system can create an occupancy grid, as shown in FIG. 3, element 328. In this way, the point cloud can be projected onto the grid. However, since the principles and methods described here result in a labeled point cloud, the labels must now be taken into account. For example, a grid cell can be labeled as dynamic if a number of unknown or dynamic points within the grid is above a threshold. Conversely, the grid cell can be labeled as static if the number of unknown or dynamic points is below the threshold value. The lower this threshold value is, the safer the robot naturally works. Conversely, the higher the threshold value, the lower the resulting safety margins.

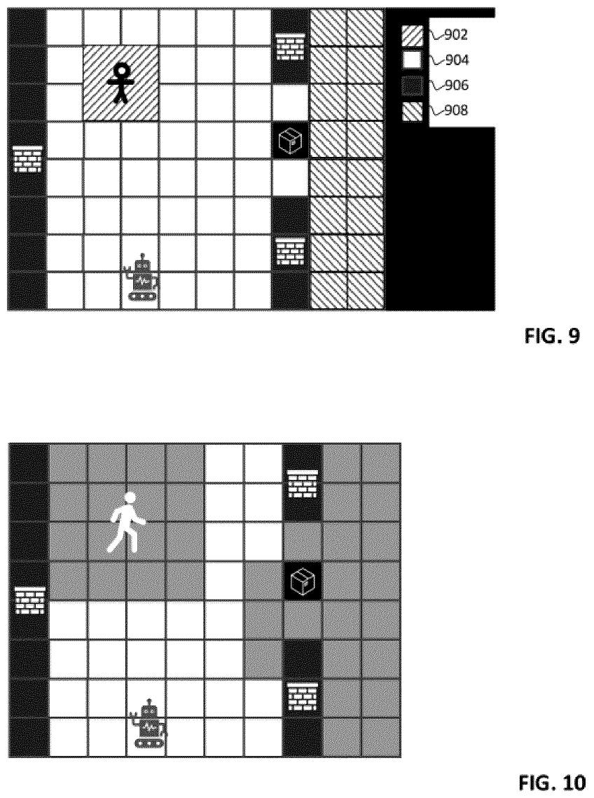

FIG. 9 shows an occupancy grid with 4 states (dynamic 902, free 904, static 906 and unknown 908) as described above. In this way, cells that are occupied and dynamic (e.g. with at least k unknown or dynamic points) are labeled 902. The free cells (known to be free and/or containing no corresponding point measurements) are designated 904. The occupied and static cells (with statically marked points) are denoted 906. The unknown cells are denoted 908.

As can be seen from the figure, grid cells containing only static elements are correctly identified as static, while cells corresponding to a human worker are correctly identified as dynamic. For safety purposes, it is important to know where a static or dynamic cell or object is located and how large the required safety distance to the respective cell is. In this respect, not all static cells are treated in the same way. For example, a wall cannot be walked or driven over, whereas a small object (e.g. a package, a tool, etc.) can be walked or climbed over by a person. Since there is an unknown space behind each static object, some static objects with low height may require additional steps. For example, the robot may come very close to a wall with an opening (e.g. an open door) where a dynamic object may suddenly appear.

To overcome these challenges, each occupied cell can optionally be provided with a height of a detected obstacle (e.g. from the 3D point cloud data). In this way, the resulting grid essentially becomes a 2.5D grid. In addition, a 3D grid can also be used. In addition, all cells that can potentially be reached during the robot's stopping time, whether by visible or potentially occluded dynamic objects, can be labeled as dangerous. This is illustrated in FIG. 10, where unshaded (white) cells are passable by the robot, black shaded cells represent objects or obstacles and gray shaded cells indicate danger zones where the cell is potentially reachable by both the robot and the human during the robot's stopping time. Potentially concealed dynamic objects are also displayed as danger zones in order to comply with safety standards.

As can be seen from FIG. 10, the robot can travel close to walls but must maintain a significant distance from the human and the package (as the package could be traversed by a concealed dynamic object). The resulting grid can then be provided to the robot's motion limiter, the proximity of each occupied cell (whether static or dynamic) to the robot being evaluated. Static cells may require a smaller safety distance than dynamic cells. If a violation of the safety distance is determined (i.e. the cell is too close to the robot), a safety measure (e.g. braking, slowing down) can be enforced.

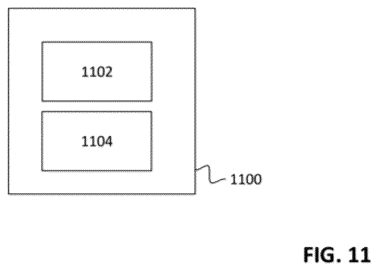

FIG. 11 shows a device 1100 for detecting a dynamic object, comprising a processor 1102 configured to determine a first point density of a first volume about a first point in a first image, the first image being an image of an environment of a robot, the image including image data corresponding to three dimensions; determine one or more second point densities, each second point density of the one or more second point densities being a point density of a second volume about a second point; wherein the second point corresponds to the first point in each of one or more second images, the one or more second images of the environment being one image or more images taken prior to the first image and including image data corresponding to three dimensions; and classify the first point as dynamic or static based on a comparison of the first point density and the one or more second point densities.

In an optional configuration, the device for detecting a dynamic object may further comprise one or more image sensors 1104 configured to generate a plurality of images or depth images. In this manner, the processor 1102 may be further configured to generate the point cloud images by resolving the plurality of images or depth images with a position of the one or more image sensors when the plurality of images or depth images are acquired. The one or more image sensors 1104 may be a stereo camera or a depth camera, a LiDAR device, or any other device capable of generating image data with respect to three dimensions. Additionally or alternatively, the one or more image sensors 1104 may be two-dimensional camera sensors configured to generate two-dimensional images. In this case, the one or more processors 1102 may further be configured to generate the point cloud images by resolving the multiple two-dimensional images using one or more photogrammetry techniques.

In an optional configuration, the processor may be configured to determine a first depth information of the first point within the first recording (e.g., in the first depth information image) and a second depth information for each second point in the one or more second images (e.g., one or more second recordings). The processor may further be configured to generate (or alternatively select), using the first depth information and the second depth information, a modified image set as an image set including the one or more second images in which the first depth information corresponds to a depth greater than a depth of the second depth information of the corresponding second image. In this way, classifying the first point as dynamic or static based on the comparison of the first point density and the one or more second point densities may include classifying the first point as dynamic or static based on a comparison of the first point density and the one or more second point densities of the modified second image set.

In a further optional configuration, the processor may further be configured to change the second volume based on a comparison of the depth information of the first point and the depth information of the second point. In this way, the volume to be analyzed can be increased or decreased based on the depth information. In this way, the volume to be analyzed can be changed based on the relative movement of the device for detecting a dynamic object (optionally configured as a robot) toward or away from the object. This adjustment helps to correct for the fact that an object that is closer to the robot occupies a larger part of the robot's field of view and therefore generates more corresponding points in the point cloud. Therefore, the volume to be analyzed can be reduced to correct this phenomenon. Conversely, if the relative distance between the device and the object increases, the volume can be increased to account for the change in size within the robot's field of view.

In this way, the change in the volume surrounding the second point based on the depth information of the first point compared to the depth information of the second point may include an increase in the second volume if the first depth information corresponds to a depth less than a depth of the second depth information, and a decrease in the second volume if the first depth information corresponds to a depth greater than a depth of the second depth information.

This document refers several times to the measurement of a volume surrounding a point. The term “volume” used here is intended to describe a three-dimensional space. The volume described here can optionally be spherical. A spherical volume can alternatively be understood as a three-dimensional area defined by all points with a predetermined radius from a central point. Although several references are made herein to a spherical volume, the volume to be measured may alternatively be defined by shapes other than a sphere, and spherical volume is used herein merely for simplicity.

In an alternative configuration, a third category “unknown” can be used so that the processor can optionally be configured to characterize a point as static, dynamic or unknown. The introduction of this third category (e.g. the “unknown” category) can simplify future calculations and improve the overall operation of the device. It may be undesirable to allow a fast transition from static to dynamic or dynamic to static; however, this can be mitigated somewhat by requiring a slightly longer transition between static and dynamic, but allowing a slightly faster transition between static and unknown and between dynamic and unknown. One effect of using the “unknown” category is that newly discovered points can be classified as unknown and not as dynamic. This avoids having to classify all newly detected points as dynamic, as such a classification would lead to significant and possibly even impractical restrictions on the movement of the device.

In this disclosure, the captured images with depth information are described as a point cloud that is rendered. The point cloud may include a discrete set of data points in space. These data points may, in combination with each other, represent one or more three-dimensional shapes or objects. The points can be positioned or rendered within a set of Cartesian coordinates along 3 axes.

In an optional configuration, the device may be configured to operate in one or more modes of operation depending on whether an object is classified as static or dynamic. In particular, the processor may be configured to operate in a first mode of operation if the distance between the robot and an object corresponding to a static point is within a predetermined range, and to operate in a second mode of operation if the distance between the robot and the object corresponding to a dynamic point is within the predetermined range. The first mode of operation may include the processor not sending a command to slow down or stop the robot; and wherein the second mode of operation may include the processor sending a command to slow down or stop the robot.

The device for detecting a dynamic object described herein may optionally be configured as an autonomous robot. In this way, the autonomous robot may further comprise one or more positioning sensors for determining the position of the autonomous robot with respect to one or more reference points and a motion system for causing the robot to move or locomote.

In this description, amongst others, a comparison between a first volume and a second volume is described. The first volume and the second volume may alternatively be understood as a first area and a second area or a first region and a second region.

In a possible configuration, the center of the first volume has the same x, y and z coordinates as the center of the second volume. In this configuration, a first point density around the center of the first volume is compared to a second point density around the center of the second volume, where the first center and the second center have the same position, but in different images. As described above, the size of the first volume may be equal to the size of the second volume. Alternatively, the size of the first volume may be larger or smaller than the size of the second volume.

In an alternative configuration, the center of the first volume has different x-, y- or z-coordinates as the center of the second volume. In this configuration, for example, the center of the first volume is adjusted based on a change of location or movement of the sensor (e.g. the device performing this method) or even based on a change of location or movement of an object. At this point, the size of the first volume may again be equal to the size of the second volume, or the size of the first volume may be larger or smaller than the size of the second volume.

Further aspects of this description are disclosed with reference to the following examples:
Example 1 is a device for detecting a dynamic object, comprising a processor configured to determine a first point density of a first volume about a first point in a first image, the first image being an image of an environment of a robot, the image including image data corresponding to three dimensions; determine one or more second point densities, each second point density of the one or more second point densities being a point density of a second volume about a second point, the second point corresponding to the first point in each of one or more second images, the one or more second images of the environment being one image or more images taken prior to the first image, and including image data corresponding to the three dimensions; and classify the first point as dynamic or static based on a comparison of the first point density and the one or more second point densities.
In Example 2, the subject matter of Example 1 may optionally include that the processor is further configured to determine a first depth information of the first point within the first image; determine a second depth information for each second point in the one second image or in the more second images; and generate a modified image set as an image set having the one or more second images in which the first depth information corresponds to a greater depth than a depth of the second depth information of the corresponding second image; wherein classifying the first point as dynamic or static based on the comparison of the first point density and the one or more second point densities comprises classifying the first point as dynamic or static based on a comparison of the first point density and the one or more second point densities of the modified second image set.
In Example 3, the subject matter of any one of Examples 1 or 2 may optionally include that the processor is further configured to vary the second point density based on a comparison of the depth information of the first point and the depth information of the second point.
In Example 4, the subject matter of Example 3 may optionally include that varying the point density surrounding the second point based on a depth information of the first point compared to a depth information of the second point comprises increasing the second point density if the first depth information corresponds to a smaller depth than a depth of the second depth information, and decreasing the second point density if the first depth information corresponds to a greater depth than a depth of the second depth information.
In Example 5, the subject matter of any one of Examples 1 to 4 may optionally include that the first volume and the second volume are spherical.
In Example 6, the subject matter of any one of Examples 1 to 5 may optionally comprise that the processor is further configured to classify the first point as dynamic, static, or unknown based on the comparison of the first point density and the one or more second point densities.
In Example 7, the subject matter of any one of Examples 1 to 6 may optionally include that the first image of the environment and the one or more second images of the environment are configured as point cloud images.
In Example 8, the subject matter of any one of Examples 1 to 7 may optionally include that device further comprises one or more image sensors configured to generate a plurality of images or depth images; wherein the processor is further configured to generate the point cloud images by resolving the plurality of images or depth images with a position of the one or more image sensors when the plurality of images or depth images have been captured.
In Example 9, the subject matter of Example 8 may optionally include that the one or more image sensors comprise a stereo camera or a depth camera.
In Example 10, the subject matter of Example 8 may optionally include that the image generator is a LiDAR, Light Detection and Ranging, device.
In Example 11, the subject matter of Example 8 may optionally include that the device further comprises one or more image sensors configured to generate a plurality of images; wherein the processor is further configured to generate the point cloud images by resolving the plurality of images using one or more photogrammetry techniques. In an optional configuration, the image sensor or the multiple image sensors may be depth or distance image sensors.
In Example 12, the subject matter of any one of Examples 1 to 11 may optionally comprise that the processor is further configured to generate a modified data set by removing from the first image and the one or more second images data corresponding to a surface traversable by the device for detecting dynamic objects; and wherein classifying the first point as dynamic or static comprises classifying the first point as dynamic or static based on a comparison of the density of the first point and the density of the one or more second points within the modified data set.
In Example 13, the subject matter of any one of Examples 1 to 12 may optionally comprise that the processor is further configured to generate a two-dimensional grid of the environment and label parts of the two-dimensional grid as dynamic or static based on classifying the first point as dynamic or static based on the comparison of the first point density and the one or more second point densities.
In Example 14, the subject matter of any one of Examples 1 to 13 may optionally comprise that the processor is configured to operate in a first mode of operation if a distance between the robot and an object corresponding to a static point is within a predetermined range, and to operate in a second mode of operation if the distance between the robot and the object corresponding to a dynamic point is within the predetermined range.
In Example 15, the subject matter of Example 14 may optionally comprise that the first mode of operation comprises that the processor does not send a command to slow down or stop the robot; and wherein the second mode of operation comprises that the processor sends a command to slow down or stop the robot.
In Example 16, the subject matter of any one of Examples 1 to 15 may optionally comprise that the device for detecting dynamic objects is configured as an autonomous robot.
Example 17 is a method for detecting a dynamic object, comprising: determining a first point density of a first volume around a first point in a first image, the first image being an image of an environment of a robot, the image including image data corresponding to three dimensions; determining one or more second point densities, wherein each second point density of the one or more second point densities is a point density of a second volume around a second point; wherein the second point corresponds to the first point in each of one or more second images, the one or more second images of the environment being one or more images taken prior to the first image and including image data corresponding to the three dimensions; and classifying the first point as dynamic or static based on a comparison of the first point density and the one or more second point densities.
In Example 18, the subject matter of Example 17 may optionally comprise that the method further comprises: determining a first depth information of the first point within the first image; determining a second depth information for each second point in the one second image or in the more second images; and determining a modified image set as an image set having the one or more second images in which the first depth information corresponds to a greater depth than a depth of the second depth information of the corresponding second image; wherein classifying the first point as dynamic or static based on the comparison of the first point density and the one or more second point densities comprises classifying the first point as dynamic or static based on a comparison of the first point density and the one or more second point densities of the modified second image set.
In Example 19, the subject matter of any one of Examples 17 or 18 may optionally comprise that the method further comprises: varying the second point density based on a comparison of the depth information of the first point and the depth information of the second point.
In Example 20, the subject matter of Example 19 may optionally comprise that varying the point density surrounding the second point based on a depth information of the first point compared to a depth information of the second point comprises increasing the second point density if the first depth information corresponds to a smaller depth than a depth of the second depth information, and decreasing the second volume if the first depth information corresponds to a greater depth than a depth of the second depth information.
In Example 21, the subject matter of any one of Examples 17 to 20 may optionally comprise that the method further comprises: classifying the first point as dynamic, static or unknown based on the comparison of the first point density and the one or more second point densities.
In Example 22, the subject matter of any one of Examples 17 to 21 may optionally comprise that the first image of the environment and the one or more second images of the environment are configured as point cloud images.
In Example 23, the subject matter of Example 22 may optionally comprise that the method further comprises: generating the point cloud images by resolving the plurality of images or depth images with a position of one or more image sensors when the plurality of images or depth images have been captured.
In Example 24, the subject matter of any one of Examples 17 to 23 may optionally comprise that the method further comprises: generating a modified data set by removing from the first image and the one or more second images data corresponding to a surface traversable by the device for detecting dynamic objects; and wherein classifying the first point as dynamic or static comprises classifying the first point as dynamic or static based on a comparison of the density of the first point and the density of the one or more second points within the modified data set.
In Example 25, the subject matter of any one of Examples 17 to 24 may optionally comprise that the method further comprises: generating a two-dimensional grid of the environment; and labeling parts of the two-dimensional grid as dynamic or static based on classifying the first point as dynamic or static based on comparing the first point density and the one or more second point densities.
In Example 26, the subject matter of any one of Examples 17 to 25 may optionally comprise that the method further comprises: operating in a first mode of operation if a distance between the robot and an object corresponding to a static point is within a predetermined range; and operating in a second mode of operation if the distance between the robot and the object corresponding to a dynamic point is within the predetermined range.
In Example 27, the subject matter of Example 26 may optionally comprise that the first mode of operation comprises that no command is sent to slow down or stop the robot; and wherein the second mode of operation comprises that a command is sent to slow down or stop the robot.
Example 28 is a non-volatile computer-readable medium comprising instructions that, if executed by a processor, cause the processor to perform the method of any one of Examples 17-27.
In Example 29, the subject matter of any one of Examples 1 to 15 may optionally comprise that the device is a safety device for distinguishing dynamic and static objects.
In Example 30, the subject matter of any one of Examples 3 to 15 may optionally comprise that the processor is further configured to increase the second volume if the depth information corresponds to a greater distance to the first point than to a second point, or to decrease the second volume if the depth information corresponds to a smaller distance to the first point than to a second point.
In Example 31, the subject matter of Example 14 may optionally comprise that the processor is further configured to associate a height information with at least one cell of the grid, and if the height information is within a range, to calculate a first minimum distance to be maintained to an object in the cell, and if the height information is outside the range, to calculate a second minimum distance to be maintained to an object in the cell, wherein the first minimum distance is greater than the second minimum distance.
In Example 32, the subject matter of any one of Examples 1 to 17 may optionally comprise that the processor is configured to compare the depth information for a point with an estimated depth information for the point and to characterize the point as occluded if a difference between the depth information and the estimated depth information is outside a range and to characterize the point as visible if a difference between the depth information and the estimated depth information is within a range.
In Example 30, the subject matter of any one of Examples 1 to 32 may optionally comprise that the second point corresponds to the first point in each of one or more second images.
In Example 31, the subject matter of any one of Examples 1 to 16 may optionally comprise that the device for detecting a dynamic object is configured as an autonomous or semi-autonomous robot.
In Example 32, the subject matter of any one of Examples 1 to 16 may optionally comprise that the device for detecting a dynamic object is configured as a vehicle. A device for detecting a dynamic object according to any one of claims 1 to 31, wherein the device for detecting dynamic objects is configured as an autonomous robot.

Although the above descriptions and associated figures may represent components as separate elements, those skilled in the art understand the various ways to combine or integrate discrete elements into a single element. This may include combining two or more circuits to form a single circuit, mounting two or more circuits on a common chip or chassis to form an integrated element, running discrete software components on a common processor core, etc. Conversely, a person skilled in the art will recognize the possibility of separating a single element into two or more discrete elements, such as splitting a single circuit into two or more separate circuits, separating a chip or chassis into discrete elements originally provided thereon, separating a software component into two or more sections and executing each on a separate processor core, etc.

It will be understood that implementations of methods described in detail herein are demonstrative and are thus understood to be capable of being implemented in a corresponding device. Similarly, it will be understood that implementations of devices described in detail herein are understood to be capable of being implemented as a corresponding method. Thus, it will be understood that a device corresponding to a method described in detail herein may include one or more components adapted to perform any aspect of the associated method.

All acronyms defined in the above description also apply in all claims contained herein.

1. A device for detecting a dynamic object, comprising:
a processor, configured to:
determine a first point density of a first volume around a first point in a first image, the first image being an image of an environment of a robot, the image comprising image data corresponding to three dimensions;
determine one or more second point densities, each second point density of the one or more second point densities being a point density of a second volume around a second point; wherein the one or more second images of the environment are one or more images taken prior to the first image and include image data corresponding to the three dimensions; and
classify the first point as dynamic or static based on a comparison of the first point density and the one or more second point densities.

2. The device for detecting a dynamic object of claim 1, wherein the processor is further configured to:
determine a first depth information of the first point within the first image;
determine a second depth information for each second point in the one or more second images; and
determine a modified image set as an image set having one or more second images in which the first depth information corresponds to a greater depth than a depth of the second depth information of the corresponding second image;
wherein classifying the first point as dynamic or static based on the comparison of the first point density and the one or more second point densities comprises classifying the first point as dynamic or static based on a comparison of the first point density and the one or more second point densities of the modified second image set.

3. The device for detecting a dynamic object of claim 1, wherein the processor is further configured to change the second point density based on a comparison of the depth information of the first point and the depth information of the second point.

4. The device for detecting a dynamic object of claim 3, wherein the processor is further configured to increase the second point density if the depth information corresponds to a greater distance to the first point than to a second point, or to decrease the second volume if the depth information corresponds to a smaller distance to the first point than to a second point.

5. The device for detecting a dynamic object of claim 4, wherein varying the point density surrounding the second point based on a depth information of the first point compared to a depth information of the second point comprises increasing the second point density when the first depth information corresponds to a depth less than a depth of the second depth information, and decreasing the second point density when the first depth information corresponds to a depth greater than a depth of the second depth information.

6. The device for detecting a dynamic object of claim 1, wherein the first volume and the second volume are spherical.

7. The device for detecting a dynamic object of claim 1, wherein the processor is further configured to classify the first point as dynamic, static, or unknown based on the comparison of the first point density and the one or more second point densities.

8. The device for detecting a dynamic object of claim 1, wherein the first image of the environment and the one or more second images of the environment are configured as point cloud images.

9. The device for detecting a dynamic object of claim 8, further comprising one or more image sensors configured to generate a plurality of images or depth images;
wherein the processor is further configured to generate the point cloud images by resolving the plurality of images or depth images with a position of the one or more image sensors when the plurality of images or depth images are acquired.

10. The device for detecting a dynamic object of claim 9, wherein the one or more image sensors comprise a stereo camera or a depth camera.

11. The device for detecting a dynamic object of claim 9, wherein the image generator is a LiDAR, Light Detection and Ranging, device.

12. The device for detecting a dynamic object of claim 9, further comprising one or more image sensors configured to generate a plurality of images;
wherein the processor is further configured to generate the point cloud images by resolving the plurality of images using one or more photogrammetry techniques.

13. The device for detecting a dynamic object of claim 1, wherein the processor is further configured to generate a modified data set by removing from the first image and the one or more second images data corresponding to a surface traversable by the dynamic object detection device; and wherein classifying the first point as dynamic or static comprises classifying the first point as dynamic or static based on a comparison of the density of the first point and the density of the one or more second points within the modified data set.

14. The device for detecting a dynamic object of claim 1, wherein the processor is further configured to generate a two-dimensional grid of the environment and to label portions of the two-dimensional grid as dynamic or static based on classification of the first point as dynamic or static based on comparison of the first point density and the one or more second point densities.

15. The device for detecting a dynamic object of claim 14, wherein the processor is further configured to associate height information with at least one cell of the grid, and when the height information is within a range, to calculate a first minimum distance to be maintained to an object in the cell, and when the height information is outside the range, to calculate a second minimum distance to be maintained to an object in the cell, wherein the first minimum distance is greater than the second minimum distance.

16. The device for detecting a dynamic object of claim 1, wherein the processor is configured to operate in a first mode of operation when a distance between the robot and an object corresponding to a static point is within a predetermined range, and to operate in a second mode of operation when the distance between the robot and the object corresponding to a dynamic point is within the predetermined range.

17. The device for detecting a dynamic object of claim 16, wherein the first mode of operation comprises the processor not sending a command to decelerate or stop or perform an avoidance maneuver of the robot; and wherein the second mode of operation comprises the processor sending a command to decelerate or stop or perform an avoidance maneuver of the robot.

18. The device for detecting a dynamic object of claim 1, wherein the processor is configured to compare the depth information for a point to an estimated depth information for the point and label the point as being occluded if a difference between the depth information and the estimated depth information is outside a range and to label the point as being visible if a difference between the depth information and the estimated depth information is within a range.

19. The device for detecting a dynamic object of claim 1, wherein the dynamic object detection device is configured as an autonomous robot.

20. A method for detecting a dynamic object, comprising:
determining a first point density of a first volume around a first point in a first image, the first image being an image of an environment of a robot, the image including image data corresponding to three dimensions;
determining one or more second point densities, each second point density of the one or more second point densities being a point density of a second volume about a second point; the second point corresponding to the first point in each of one or more second images, the one or more second images of the environment being one or more images taken prior to the first image and including image data corresponding to the three dimensions; and
classifying the first point as dynamic or static based on a comparison of the first point density and the one or more second point densities.
